(19) United States
(12) Patent Application Publication
(10) Pub. No.: US 2013/0001167 A1
(43) Pub. Date: Jan. 3, 2013

(54) PROCESS FOR WATER SOFTENING

(75) Inventor: Allen Wallace Apblett, Stillwater, OK (US)

(73) Assignee: THE BOARD OF REGENTS FOR OKLAHOMA STATE UNIVERSITY, Stillwater, OK (US)

(21) Appl. No.: 13/583,506

(22) PCT Filed: Mar. 8, 2011
(86) PCT No.: PCT/US11/27585

§ 371 Date: Sep. 7, 2012

Related U.S. Application Data
(60) Provisional application No. 61/311,681, filed on Mar. 8, 2010.

(51) Int. Cl. C02F 1/42; C02F 101/10

(52) U.S. Cl. 210/670

(57) ABSTRACT

A method is described for removing hard water components from water wherein the removed ions are not replaced by sodium ions. The method includes the steps of passing water having dissolved hard water components through a water-softening column containing a tungsten-based sorbent. The hard water components are reacted with tungsten based sorbent to remove the hard water components. The tungsten based sorbent is regenerated for later use in the step of reacting. The resulting by-products include calcium and magnesium or ammonium nitrate, all of which may be sold and used for various purposes.

### RELATED CASE

This application claims the benefit of U.S. Provisional Patent Application Ser. No. 61/311,681 filed on Mar. 8, 2010 and incorporates said provisional application by reference.

### FIELD OF THE INVENTION

The invention relates to a process for water softening. More particularly, the invention relates to a process for water softening wherein removed ions are not replaced by sodium ions.

### BACKGROUND OF THE INVENTION

A water softener is used to remove dissolved calcium and magnesium ions from hard water. This is desirable because these “hardness ions” hinder the ability of soap and detergents to lather and clean (forming a precipitate such as a bathtub ring) and they also precipitate out as hard deposits on the surfaces of pipes, heat exchanger surfaces, and in hot water tanks. Conventional water-softening devices use an ion-exchange resin that exchanges sodium ions for the hard metal ions. As these resins become loaded with undesirable cations they gradually lose their effectiveness and must be regenerated. This process usually involves passing a concentrated brine of sodium chloride through a water-softening column.

There are three major problems associated with the current technology that make the proposed technology solution of the invention extremely commercially viable. First, the released sodium can readily cause a person to exceed the recommended daily intake of sodium if the treated water is used for drinking water. Considering that 3% of the population is on a sodium-reduced diet, this can be very problematic. The only solutions for this are separate faucets in the house for drinking water that bypass the water softener but they would then have the inherent problems of hard water or the installation of a reverse osmosis unit for the drinking and cooking water at an additional expense.

Secondly, the sodium ions in the softened water are much more electrolytically active than the calcium or magnesium ions that they replace leading to a substantial increase in galvanic corrosion. This is particularly problematic at pipe welds and showerheads, faucets, etc. Further, if any lead plumbing is in use, softened water is much more likely to mobilize the lead and pose a severe health problem.

Finally, the salts used for regeneration get flushed out of the system into sewers or septic systems and can be quite damaging to the environment. Many jurisdictions have begun to prohibit such releases, often requiring users to dispose of the spent brine at an approved site or to use a commercial service company. On an industrial scale, water-softening plants generate significant amounts of brine effluent leading to high disposal costs and choking off of pipes due to deposition of lime scale.

A water-softening technology that does not replace the removed ions with sodium ions and that also does not require the use of regeneration solutions by the consumer is, therefore, desirable.

### SUMMARY OF THE INVENTION

This invention relates to a method for removing hard water components (calcium and magnesium) and heavy metals (e.g. lead, uranium, and copper). Unlike other methods, the method of the invention does not replace removed ions with sodium ions. Therefore, the method can be used to treat potable water. Furthermore, the method does not require regeneration solutions. Instead, in a preferred embodiment, the loaded water treatment column can be returned for separation of the absorbed ions from the sorbent materials followed by reuse of the sorbent material in a new column. The resulting calcium and magnesium containing by-products can be sold for use in other industrial products such as cement.

The method and apparatus of the invention is an innovative technology for water softening treatment that does not generate a brine waste stream nor does it release harmful ions into the water. The technology of the present disclosure can sharply reduce the costs and negative environmental impacts of water softening. The process involves reaction with a tungsten-based sorbent to produce insoluble calcium and magnesium tungstates.

This reaction releases acid that can be captured downstream from the sorbent by an amine-containing polymer also leading to removal of problematic anions such as sulfates and chloride. Once a column becomes loaded with hard water ions it may be returned to the supplier where the tungsten compound can easily be separated from the calcium and magnesium ions. In this process, the latter may be isolated as hydroxide salts that could be used directly in a variety of industrial processes including cement manufacture (while saving green house gas emissions at the same time). The tungsten compound would then be used to synthesize tungstic acid for recharging of the water softening columns. The only “waste” product from the entire process is ammonium nitrate or sulfate that is suitable for fertilizer use. An alternative process would regenerate the tungstic acid directly and produce the chloride salts of the hard water ions.

### BRIEF DESCRIPTION OF THE DRAWINGS

FIG. 1 is a chemical reaction summary of the water softening process of the invention.

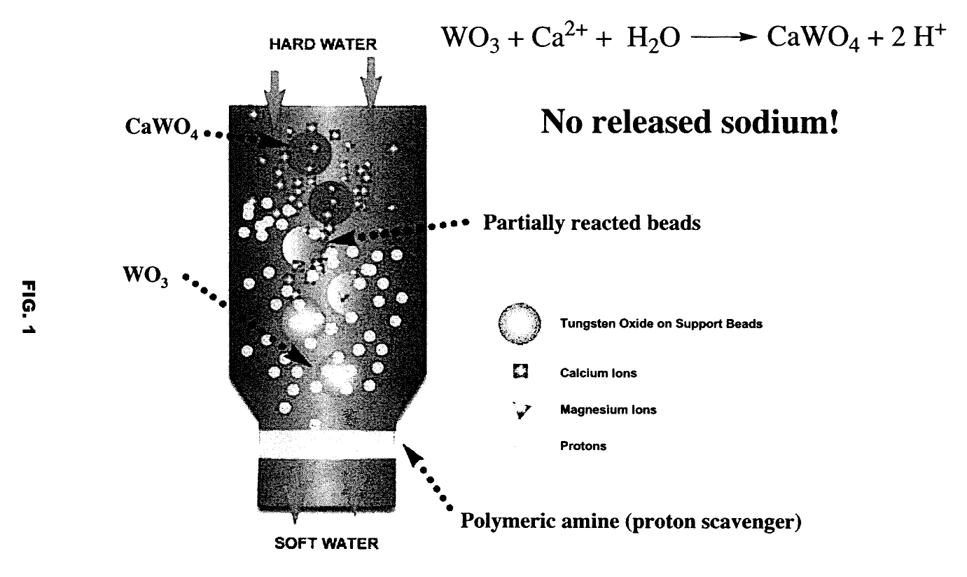

FIG. 2 is a graphical representation of an X-ray powder diffraction pattern for the product (MgWO₄, ICDD #19-0076) formed from the reaction of WO₃ with magnesium acetate.

FIG. 3 is a graphical representation of X-ray powder diffraction pattern for the product of (CaWO₄, ICDD 41-1431) from the reaction of WO₃ with calcium acetate.

### DETAILED DESCRIPTION OF THE PREFERRED EMBODIMENTS

The invention is an innovative technology for water softening treatment that does not generate a brine waste stream nor does it release harmful ions into the water. The technology can sharply reduce the costs and negative environmental impacts of water softening. The process involves reaction of the untreated hard water with a tungsten-based sorbent to produce insoluble calcium and magnesium tungstates. This reaction releases acid that is captured downstream from the sorbent by an amine-containing polymer also leading to removal of problematic anions such as sulfates and chloride. Once a column becomes loaded with hard water ions the tungsten compound can easily be separated from the calcium and magnesium ions. In this process, the latter are isolated as hydroxide salts that could be used directly in a variety of industrial processes including cement manufacture (while saving green house gas emissions at the same time). The tungsten compound would then be reused to recharge the water-softening columns. The only “waste” product from the entire process is ammonium or potassium sulfate that would be suitable for fertilizer use. Indeed, a small profit can be derived from the regeneration process since the chemicals generated can be sold for more than the cost of the chemicals used.

### Supporting Experiments

Reaction of WO₃ with Magnesium Salts

6.0 mmol of tungsten trioxide powder WO₃ (1.391 g) was added to 12 mmol of a solution of either magnesium acetate, magnesium hydroxide, or magnesium chloride in 100 ml of deionized water. The mixtures were stirred magnetically and heated at reflux for 72 hours. Upon cooling, the solid obtained was isolated by vacuum filtration through a fine sintered glass filter and washed copiously with distilled water and then was dried in an oven overnight.

Reaction of WO₃ with Calcium Salts

6.0 mmol of WO₃ was added to 12 mmol of a solution of either calcium acetate, calcium hydroxide, or calcium chloride in 100 ml of deionized water. The mixtures were stirred magnetically and heated at reflux for 72 hours. Upon cooling, a white solid was isolated by filtration through a fine sintered glass filter and washed copiously with distilled water and then was dried in an oven overnight.

Reacting Alkaline Earth Metals with Tungstic Acid

8 mmol of H₂WO₄ was added to 16 mmol of a solution of either magnesium acetate or calcium acetate. The mixtures of magnesium acetate and calcium acetate were heated at reflux for five minutes. Upon cooling, the solid obtained in each experiment was isolated by filtration through a fine sintered glass filter and washed copiously with distilled water and then was dried in an oven overnight.

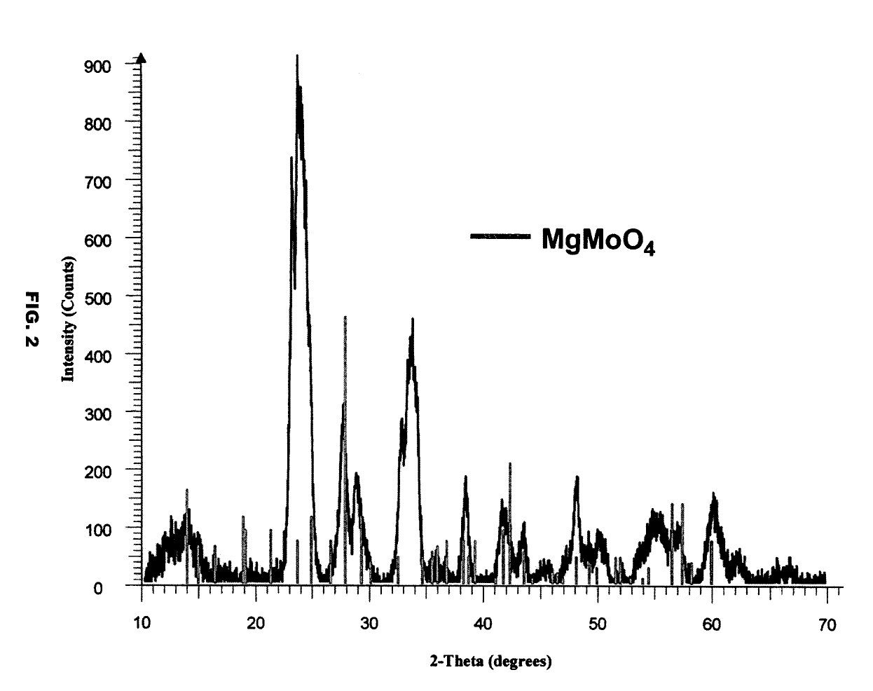

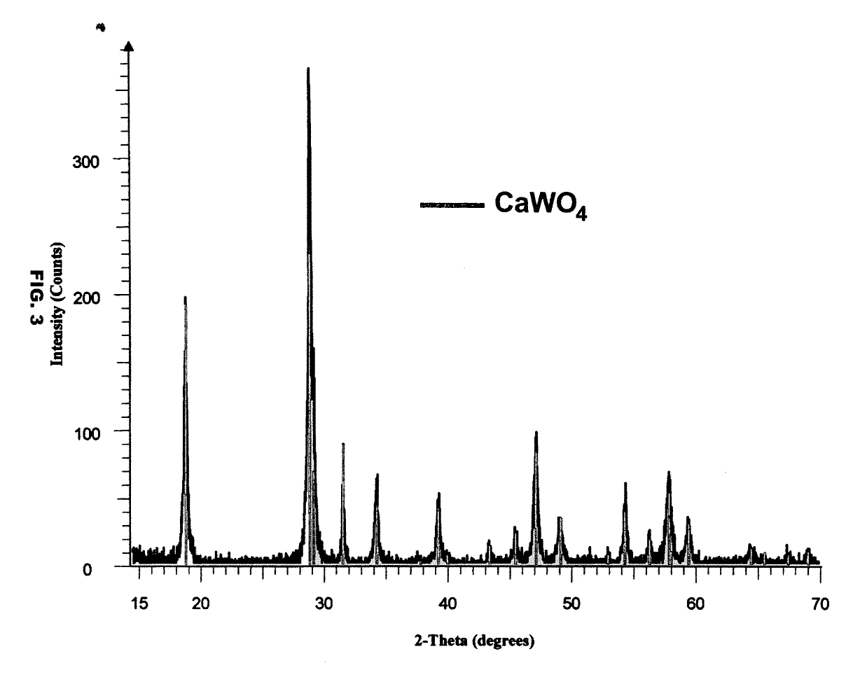

Accelerated reactions were performed between the main components of hard water, calcium and magnesium ions in refluxing aqueous solution with tungsten trioxide and tungstic acid. The hard water ions were removed from solution in the form of insoluble tungstate salts. X-ray powder diffraction analysis of the resulting solids (FIGS. 2 and 3) showed diffraction lines characteristic of the respective phase-pure tetragonal earth metal tungstates: MgWO₄ and CaWO₄, respectively. The magnesium product was not phase-pure but also contained an as-yet unidentified magnesium molybdenum oxide hydrate. Heating to 600° C. completed the conversion to MgWO₄. Similar results were obtained using tungstic acid instead of tungsten trioxide.

In all cases the yield of the metal tungstate was quantitative, meaning that the capacity for the hard water ions is 10.5% by weight for magnesium and 17.3% by weight for calcium. The uptake is fairly independent of the anion used.

TABLE 1
Percent yield of calcium and magnesium tungstate from the reaction of
various salts with tungsten trioxide in water.

| | Acetate | Hydroxide | Chloride |
|---|---|---|---|
| Magnesium | 99% | 99% | — |
| Calcium | 96% | 100% | 98% |

Tungstic acid reacts with calcium in water to produce calcium tungstate according to the equation shown below. Therefore, the theoretical uptake capacity for one metric ton of tungstic acid is 160.41 Kg of calcium. Assuming water with a moderate hardness of 265 ppm, it would be possible to treat 6.05×10⁶ liters of water or approximately 160,000 U.S. gallons of water. Note that protons are released by the reaction with calcium. The acidity would be removed from the treated water by an inexpensive amine-containing polymer at the end of the tungstic acid column.

H₂WO₄+Ca²⁺→CaWO₄+2H⁺

### Recycling of Tungstic Acid

The tungstic acid can be regenerated in a manner that generates saleable by-products. There are two possibilities for the regeneration process, a single step process that generates calcium and magnesium chlorides as by-products, and a two-step process that generates calcium hydroxide and magnesium hydroxide and either potassium sulfate or ammonium sulfate as by-products.

### Single Step Process

When a column containing calcium is flushed with hot 20% aqueous hydrochloric acid the calcium dissolves as calcium chloride and the tungstic acid is regenerated. In the case of tungstic acid on a high surface area support, this is considered the preferred method providing the tungstic acid remains on the support and does not come loose during regeneration. The calcium chloride can be captured and sold as a commodity.

CaWO₄₍ₛ₎+2HCl_{(aq)}→H₂WO₄₍ₛ₎+CaCl_{2(aq)}

In the case of magnesium, the regeneration process is the same but it produced magnesium chloride as the by-product. Columns that were used to treat hard water would contain a mixture of calcium, magnesium, and possibly iron. Thus the regeneration process will produce an aqueous solution containing a mixture of these ions.

### Two Step Process

The two step process would likely be run after the material is removed from the column and is most suited for an unsupported tungstic acid. For example, calcium tungstate is first treated with an aqueous base (potassium hydroxide or ammonium hydroxide) to dissolve the tungsten and precipitate calcium hydroxide. The calcium hydroxide is removed by filtration and dried for sale as a commodity chemical. The resulting aqueous tungstate solution is treated with sulfuric acid to precipitate tungstic acid. This also produces a solution either ammonium sulfate or potassium sulfate that can be isolated and sold as fertilizer. The reaction sequence would be similar for magnesium tungstate but would produce magnesium hydroxide. Tungstates produced from hard water treatment would yield a mixture of calcium, magnesium, and iron hydroxides.

CaWO₄₍ₛ₎+2KOH_{(aq)}→K₂WO_{4(aq)}+Ca(OH)₂₍ₛ₎

K₂WO_{4(aq)}+H₂SO_{4(aq)}→H₂WO₄₍ₛ₎+K₂SO_{4(aq)}

Thus, the present invention is well adapted to carry out the objectives and attain the ends and advantages mentioned above as well as those inherent therein. While presently preferred embodiments have been described for purposes of this disclosure, numerous changes and modifications will be apparent to those of ordinary skill in the art. Such changes and modifications are encompassed within the spirit of this invention as defined by the claims.

What is claimed:

1. A method of removing hard water components from water comprising steps of:
passing water having dissolved hard water components through a water softening column containing a tungsten based sorbent;
reacting said hard water components with said tungsten based sorbent to remove said hard water components;
regenerating said tungsten based sorbent for use in said step of reacting.

2. The method according to claim 1, wherein:
said hard water components include calcium, magnesium, or a combination of said calcium and said magnesium.

3. The method according to claim 2, wherein:
said step of reacting is described by the equation H₂WO₄+Ca²⁺->CaWO₄+2H⁺.

4. The method according to claim 1, wherein:
said step of regenerating generates calcium chloride as a by-product.

5. The method according to claim 4, wherein:
said step of regenerating is described by the equation CaWO₄₍ₛ₎+2HCl_{(aq)}->H₂WO₄₍ₛ₎+CaCl_{2(aq)}.

6. The method according to claim 1 wherein:
said step of regenerating generates calcium hydroxide and potassium sulfate as by-products.

7. The method according to claim 5 wherein said step of regenerating comprises the steps of:
treating said calcium tungstate with an aqueous base of potassium hydroxide for dissolving tungsten and for precipitating calcium hydroxide;
removing said calcium hydroxide by filtration resulting in an aqueous tungstate solution.

8. The method according to claim 7 further comprising the steps of:
treating said aqueous tungstate solution with sulfuric acid for precipitating tungstic acid and potassium sulfate.

9. The method according to claim 1 wherein:
said step of regenerating produces calcium hydroxide and ammonium sulfate as by-products.

10. The method according to claim 5 wherein said step of regenerating comprises the steps of:
treating said calcium tungstate with an aqueous base of ammonium hydroxide for dissolving tungsten and for precipitating calcium hydroxide;
removing said calcium hydroxide by filtration resulting in an aqueous tungstate solution.

11. The method according to claim 10 further comprising the steps of:
treating said aqueous tungstate solution with sulfuric acid for precipitating tungstic acid that is readily separated from a soluble ammonium sulfate by-product.
